(19) United States
(12) Patent Application Publication
(10) Pub. No.: US 2023/0069498 A1
(43) Pub. Date: Mar. 2, 2023

(54) IMAGE-BASED PREDICTIVE DATA MODELS FOR FAILURE OF INFORMATION TECHNOLOGY DEVICES

(71) Applicant: Hewlett-Packard Development Company, L.P., Spring, TX (US)

(72) Inventors: Anton Wiranata, Boise, ID (US); Kathryn Ferguson, Boise, ID (US); Manjunath Bhuyar, Boise, ID (US); Yeswanth Siva Tej Gowd Kuruba, Bangalore (IN); Purnendu Ghosh, Bangalore (IN); Vijay Raghava Reddy Pulkam, Boise, ID (US)

(73) Assignee: Hewlett-Packard Development Company, L.P., Spring, TX (US)

(21) Appl. No.: 17/462,642

(22) Filed: Aug. 31, 2021

(51) Int. Cl. G06F 11/07; G06F 11/34; G06N 20/00

(52) U.S. Cl. CPC G06F 11/0733; G06F 11/3476; G06N 20/00; G06F 11/079; G06F 11/0751

(57) ABSTRACT

An example non-transitory computer-readable storage medium comprises instructions executable by a processor to receive data including event log data and repair event data indicative of failures of the plurality of information technology (IT) devices, generate a plurality of images corresponding to the plurality of event codes of the event log data, and train a predictive data model using the plurality of images as inputs to the predictive data model and the repair event data as known outputs. For example, the predictive data model is trained to identify a plurality of failure windows and operational windows associated with the plurality of IT devices based on the repair event data and the event log data, and classify a plurality of sliding windows associated with the plurality of images based on the plurality of failure windows and operational windows.

### BACKGROUND

Information technology (IT) devices, such as printing devices, may be used to form markings on physical mediums, among other features and operations. In some examples, printing devices may form markings on the physical medium by performing a print job. A print job may include forming markings, such as text and/or images, by transferring print materials to the physical medium.

### BRIEF DESCRIPTION OF THE DRAWINGS

FIG. 1 illustrates an example device including non-transitory computer-readable storage medium, in accordance with examples of the present disclosure.

FIG. 2 illustrates another example device including non-transitory computer-readable storage medium, in accordance with examples of the present disclosure.

FIG. 3 illustrates an example system that uses a predictive data model for predicting IT device failure, in accordance with examples of the present disclosure.

FIG. 4 illustrates an example method for training and implementing a predictive data model to predict a failure of an IT device, in accordance with examples of the present disclosure.

FIG. 5 illustrates an example print system for predicting IT device failures, in accordance with examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Documents may be used to disseminate information and may include printed forms. A printed document may be produced by a printing device based on data received from a computing device. Printing devices, such as industrial presses, commercial printers, and scanners, may have a plurality of components, both hardware and software, that make up the devices. Devices, as used herein, are not limited to printing devices, and may include other types of devices which generate and/or log event log data. Such devices may be referred to as “information technology (IT) devices”. These IT devices may experience downtime which may impact productivity and operating costs. Particular components of the IT device may cause the downtime, for instance, because of failure of the particular components. In some examples, repairing the IT device may be a reactive process. A reactive process, as used herein, includes or refers to a process that occurs after the IT device has failed, such as a particular component being replaced after the IT device is discovered to have failed and/or downtime of the IT device. A proactive process, as used herein, includes or refers to a process that occurs prior to the IT device failing and/or downtime of the IT device.

Examples of the present disclosure are directed to use of a predictive data model to predict failure of an IT device. The predictive data model may be used to identify a particular component of the IT device which is predicted to fail prior to failure of the particular component. This may reduce unplanned downtime and cost associated with repairing components and/or time conflicts for repairing components. Examples may include use of event log data and repair event data, along with machine learning (ML) techniques. For example, images of event codes from an IT device may be generated and classified using a predictive data model to provide a recommendation for repair service. The recommendation may initiate a repair performed on the IT device, such as by a technician and the technician may bring an appropriate component to perform the repair.

With examples of the present disclosure being predictive, device operations may be maintained and user experience may be improved because IT device downtime may be reduced as compared to other approaches, thus reducing IT device disruption. Examples of the present disclosure may identify which particular device or component has failed and/or is likely to fail (e.g., diagnose device failure origin), which may reduce costs and improve post-sales consumer and/or user relationships.

An IT device, as used herein, includes or refers to a device that generates event log data. Example IT devices include printing devices, image devices (e.g., scanners, fax machines, etc.), desktop computing devices, laptop computing devices, tablets, smart-wearable devices, among other devices. The IT device may be formed of and/or include a plurality of components, sometimes herein referred to as “device components.” The components may include hardware components (e.g., fuser, roller, scanner, etc.) and software components that may experience downtime. In some examples, repairs to the IT device may be predictive or a proactive process, such that the particular component is replaced prior to discovering the component has failed and/or caused downtime of the IT device.

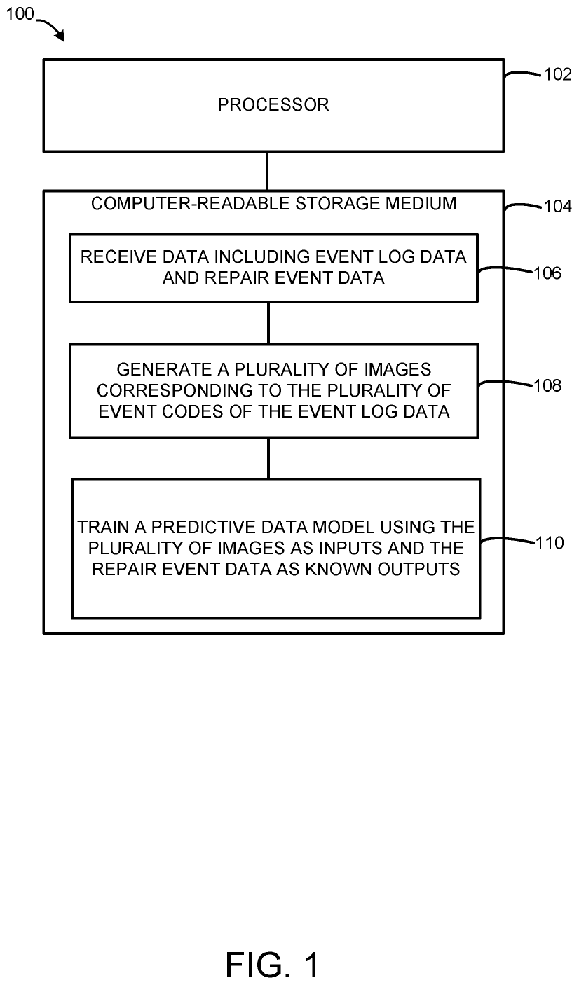

Turning now to the figures, FIG. 1 illustrates an example device including non-transitory computer-readable storage medium, in accordance with examples of the present disclosure. The device 100 includes a processor 102 and memory. The memory may include a computer-readable storage medium 104 storing a set of instructions 106, 108, and 110.

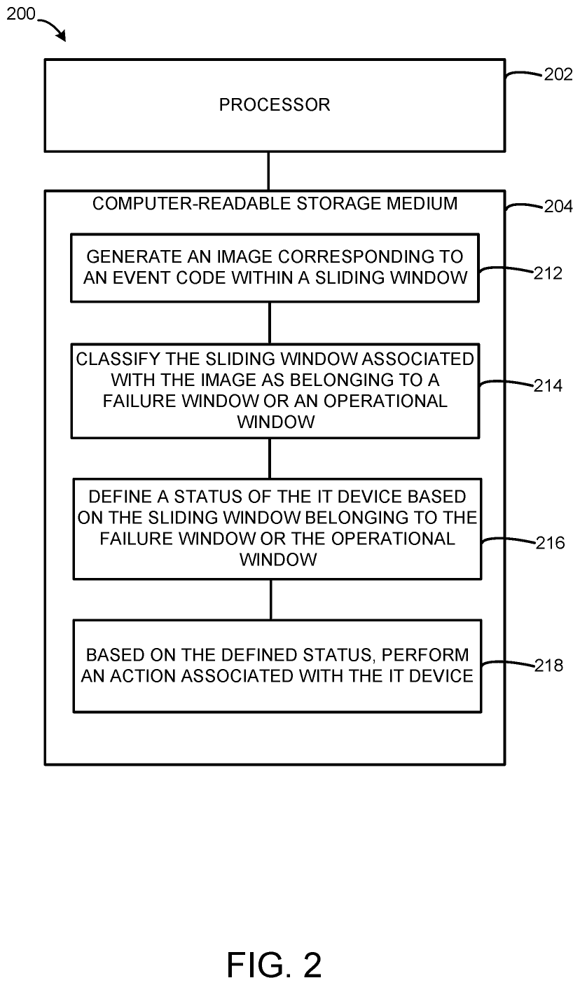

The computer-readable storage medium 104 (as well as the computer-readable storage medium 204 illustrated by FIG. 2) may include Read-Only Memory (ROM), Random-Access Memory (RAM), Electrically Erasable Programmable Read-Only Memory (EEPROM), flash memory, a solid state drive, Electrically Programmable Read Only Memory aka write once memory (EPROM), physical fuses and e-fuses, and/or discrete data register sets. In some examples, computer-readable storage medium 104 may be a non-transitory storage medium, where the term “non-transitory” does not encompass transitory propagating signals.

At 106, the processor 102 may receive data including event log data and repair event data. The event log data may include a plurality of event codes from a plurality of IT devices. The repair event data may be indicative of failures of the plurality of IT devices. The event log data may be provided by the IT devices directly to the device 100 and/or to a computing device in communication with the device 100. The repair event data may be provided from other computing devices, such as those associated with the repairs and/or being operated by an employee of a repair service provider.

In some examples, the event log data may include the event codes and information indicative of data associated with the event codes, and a type and severity level of events associated with the event codes. Event codes include information indicative of instructions received by the plurality of IT devices and indicative of respective components associated with the failures of the IT devices. The event log data may include failure information, warnings, and/or information logs, among other data. Examples include warnings related to cartridge shortage, errors in backup or firmware updates, malfunctions in a particular tray or other components of the IT device, or information and/or alerts about proper performance of a device assignment, among others. In some examples, the event code represents an instruction received by the IT device and associated with a plurality of components of the IT device including the particular component that is associated with a failure of the IT device.

The repair event data includes data indicative of an issue with the IT device, such as a repair events and/or replacement event codes. Example repair event data includes information indicative of a time of reporting, a date of reporting, identification of an issue, and/or identification of the component associated with the issue. Other example repair event data includes replacement event codes, such as data indicative of hardware replacement events. The issue may include a repair event associated with an IT device, such as a break-fix repair, as further described herein.

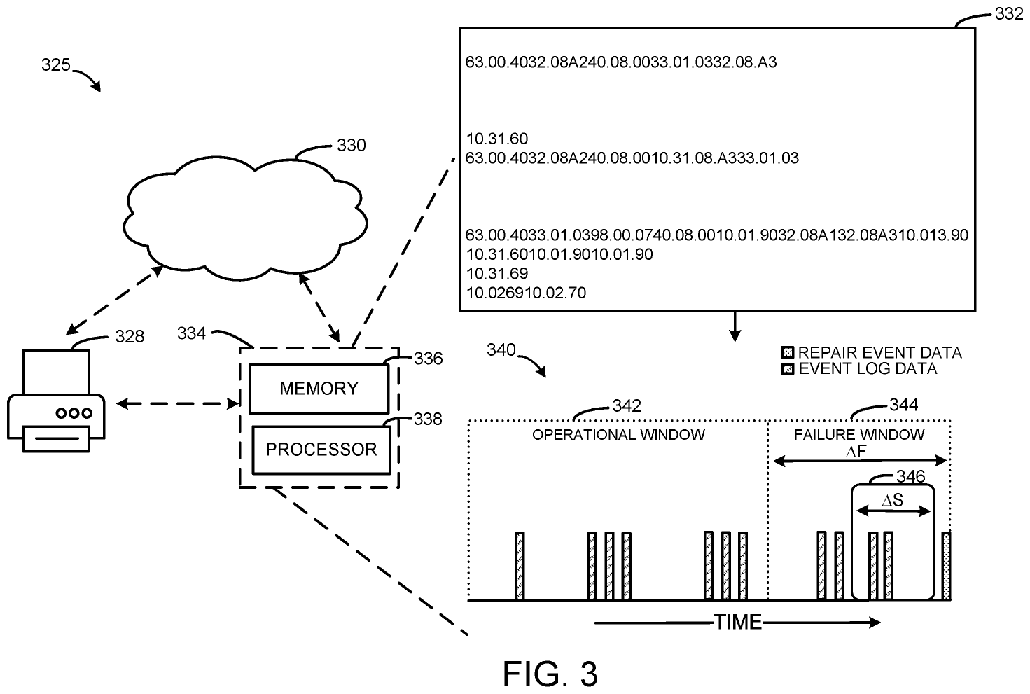

At 108, the processor 102 may generate a plurality of images corresponding to the plurality of event codes of the event log data. An image may be generated that includes the number of event codes of the plurality that occur within a period of time under analysis, sometimes herein referred to as a “sliding window” as further described below. For example, an image is generated for each sliding window, where each image includes an event code or a subset (e.g., plurality) of the plurality of event codes that occur during the respective period of time. The images may include the event codes represented visually and/or in a two-dimensional form, as further illustrated by FIG. 3.

At 110, the processor 102 may train a predictive data model using the plurality of images as inputs and the repair events as known outputs to the predictive data model. For example, the processor 102 may identify repair events (e.g., break-fix repairs) based on the repair event data, identify a plurality of failure windows and operational windows associated with the plurality of IT devices based on the identified repair events (e.g., break-fix repairs) and a size of the failure windows, and classify a plurality of sliding windows associated with the plurality of images based on the plurality of failure windows and operational windows. As used herein, a “failure window” (see, the failure window 344 from FIG. 3) includes and/or refers to a defined period of time, which may be referred to as a window of a specific length, before the IT device has a break-fix repair and sometimes including the break-fix repair. A break-fix repair may include a repair to a broken component and/or the IT device. The failure window may be a particular size, which may be set as further described herein. An “operational window” (see, the operational window 342 from FIG. 3) includes and/or refers to a defined period of time or a window of a specific length proceeding the failure window. A “sliding window” (see, the sliding window 346 from FIG. 3) includes and/or refers a defined period of time under analysis, such as a number of days or other period of times of event codes to include in an image. In some examples, the sliding window is less than the length of the failure window.

In some examples, the predictive data model may include a machine learning model (MLM) or a deep learning model (DLM). Various ML frameworks are available from multiple providers which provide open-source ML datasets and tools to enable developers to design, train, validate, and deploy MLMs and/or DLMs, such as ML/DL processors. ML/DL processors (also sometimes referred to as hardware accelerators (MLAs), or Neural Processing Units (NPUs)) may accelerate processing of MLMs and/or DLMs. ML/DL processors may be integrated circuits (ASICs) that have multi-core designs and employ precision processing with optimized dataflow architectures and memory use to accelerate and increase computational throughput when processing MLMs and/or DLMs.

MLMs and DLMs may be stored as model files having a representational data format which describes the architecture of the model (e.g., input, output, hidden layers, layer weights, nodes of each layer, interconnections between nodes of different layers, and ML/DL operations of each node/layer) along with operating parameters and, thus, describe or represent a process flow between input and output layers of an MLM/DLM. After development, the MLM/DLM may be deployed in environments other than the environment or framework in which the model is initially trained. For example, distributing computing devices of a cloud system may train the MLM/DLM and distribute the trained MLM/DLM to local computing devices and/or IT devices to implement.

In some examples, the predictive data model include a DLM and a classifier to classify the images of the event codes in sliding windows. Example DLMs include but are not limited to a Convolution Neural Network (CNN) VGG-16 model, ResNet 50, EfficientNet, and Inception. The images of the event codes may be classified using manual tagging or DL, such as object detection and categorization. The images may be classified using a Common Objects in Context (COCO) dataset and a Fast Region-Convolution Neural Network (R-CNN) and/or Mask R-CNN. Other examples may include use of COCO, Scene Understanding (SUN), ImageNet Large Scale Visual Recognition Competition (ILSVRC), Pattern Analysis Statistical Modelling and Computational Learning (PASCAL) Visual Object Classes (VOC) datasets and/or combinations thereof. Example MLMs include Faster R-CNN, You Only Look Once (YOLO), Single Shot Detector (SSD), Mask R-CNN, DeepLab, and/or Pyramid Scene Parsing Network (PSPNet). However, examples are not limited.

In some examples, the instructions to cause the processor 102 train the predictive model may include instructions to identify different patterns among the event log data that result in repair events associated with different device components based on the classified plurality of sliding windows and the plurality of failure windows and operational windows. The patterns may include different data sequences and/or sequences of event codes that result in the repair events. The repair events may include break-fix repairs which are associated with particular components of the IT devices and which are identified by the repair event data. In some examples, the repair event data may be segregated based on components by identifying repair events associated with the components. The segregated repair event data may be intersected with event log data that is associated with the respective components, such as identifying event log data associated with the respective repair events, and used to identify the patterns associated with repair events for the components. Different patterns of events codes may be identified for different sequences. In this manner, the identified patterns may capture sequences of event codes including the order of respective event codes of the plurality. The patterns identified may be used by a trained predictive model to predict future failures of the plurality of IT devices and/or additional IT devices.

In some examples, the processor 102 may train the predictive data model by selecting a size of the plurality of failure windows and a size of the plurality of sliding windows. The sliding windows may be a smaller size than the failure windows. The size may include a length of the windows or period of time of the windows. In some examples, the predictive data model may be optimized by assessing different failure window sizes and sliding window sizes, and selecting the optimal failure window size and sliding window size based on assessment of the different sizes. For example, the performance of the predictive data model may be assessed for each of the different failure window sizes and sliding window sizes combinations, and the best performance of the combinations may be selected as the failure and sliding window sizes.

In some examples, the processor 102 may further test the trained predictive data model on test data. For example, the test data may be input to the trained predictive data model, which has known repair event data that is not input to the trained predictive data model. The trained predicate data model may output predicted failure windows and/or components associated with the failure, which may be compared to the known repair event data to evaluate the performance of the trained predictive data model. Based on the performance of the test, the processor 102 may adjust the trained predictive data model. For example, the processor 102 may adjust at least one of a size of the plurality of failure windows and a size of the plurality of sliding windows based on an accuracy of the predictive data model. The adjustment described above, and further provided in other examples, may be manual or automatic by the predictive data model.

In some examples, the processor 102 may implement the trained predictive data model to predict failure of another IT device. The other IT device may be part of the plurality of IT devices or may be separate from the plurality of IT devices. The trained predictive data model may be implemented by inputting additional event log data. The additional event log data may be from the IT device and may be input in real time or near real time, and/or otherwise while the IT device is operating. The other IT device may directly communicate the event log data to the processor 102 or indirectly to another computing device that communicates with the processor 102.

As noted above, the processor 102 may revise the trained predictive data model. In some examples, the revision may be based on a test. In other examples and/or in addition, the processor 102 may revise the trained predictive data model based on feedback data. The feedback data may be indicative of or include the additional event log data and/or additional repair event data associated with the IT device and from the implementation of the trained predictive data model. In some examples, the processor 102 may revise the trained predictive data model overtime based on the performance of the model and using feedback data from a plurality of IT devices and/or other computing devices, such as additional event log data and repair event data.

As previously described, the event log data may include sequential information indicative of an order of events. In some examples, the instructions to cause the processor 102 to train the predictive data model include instructions to identify different patterns associated with the order of respective event codes that result in repair events. The different patterns may be patterns of failure of the respective components based on a sequential order of the respective event codes of the plurality of event codes, which may be associated with the respective components and/or other components, using classification results from the predictive data model applied to the images of the event codes. Based on the patterns, the sliding window and failure window sizes may be set, the trained predictive data model may be used to classify future sliding windows as belonging to a failure window or operational window. The failure window may be identified prior to a failure occurring, which may be used to reduce or prevent inoperational time for the IT device and saving the technician and/or user time and money.

In various examples, the processor 102 and computer-readable storage medium 104 may form part of the IT device, part of a remotely-located computing device, or part of a computing device that is local to the IT device, such as a local server or computer and sometimes herein referred to as “a local computing device”. In some examples, the device 100 forms part of a cloud computing system having a plurality of remotely-located and/or distributed computing devices. For example, although FIG. 1 illustrates a single processor 102 and a single computer-readable storage medium 104, examples are not so limited and may be directed to devices and/or systems with multiple processors and multiple computer-readable storage mediums. The instructions may be distributed and stored across the multiple computer-readable storage mediums and may be distributed and executed by the multiple processors.

FIG. 2 illustrates another example device including non-transitory computer-readable storage medium, in accordance with examples of the present disclosure. Similar to the device 100 of FIG. 1, the device 200 includes a processor 202 and memory that may include a computer-readable storage medium 204 storing a set of instructions 212, 214, 216, and 218. The details of the various components are not repeated.

At 212, the processor 202 may generate an image corresponding to an event code within a sliding window associated with an IT device using received event log data from the IT device. As previously described, the image includes all event codes within the sliding window, which may include an event code or a plurality of event codes. The received event log data may be received in real time and/or otherwise during operation of the IT device, as described above. In some examples, the processor 202 may retrieve the event log data associated with an event code and/or for a period of time from the IT device. At 214, the processor 202 may classify the sliding window associated with the image as belonging to a failure window or an operational window using a predictive data model applied to the image. For example, the classification may include assigning a “1” if the sliding window belongs to a failure window and assigning a “0” if the sliding window belongs to an operational window, although examples are not so limited and the reverse or other classifications may be used. The predictive data model may be trained as described above by FIG. 1. In various examples, the classification of the sliding window may be based on the image for the sliding window and surrounding sliding windows. For example, the sliding window and surrounding sliding windows may be compared to defined patterns indicative of failures of the IT device and/or components of the IT device. At 216, the processor 202 may define a status of the IT device based on the sliding window belonging to the failure window or the operational window. In some examples, the processor 202 may predict failure of the IT device and/or a component of the IT device based on the classifications of the sliding windows, as further described herein.

At 218, based on the defined status of IT device, the processor 202 may perform an action associated with the IT device. For example, in response to the classification as a failure window, the action may be performed. The action may include predicting failure of a component of the IT device, providing a message indicative of a recommendation to service the IT device, and/or determining a probability that the sliding window belongs to the failure window and/or a failure of the IT device. For example, the processor 202 may execute instructions to predict a failure of the IT device and provide a message indicative of a recommendation to service (e.g., replace or repair a component) the IT device based on the prediction. The processor 202 may further execute instructions to determine a probability that the sliding window belongs to the failure window and failure of the IT device. In some examples, the probability may include a probability of a particular component failing. In some examples, the message indicative of the recommendation to service the IT device may identify the component for repair. The service, sometimes herein referred to as a “repair service”, of the IT device may be identified prior to the failure and such that the component may be ordered if not currently and/or readily available. This may reduce IT device inoperational time and increase user satisfaction. In some examples, in response to the classification as an operational window, the action may include assessing additional event log data, such as generating additional images and classifying additional sliding windows to predict failures of the IT device, among other actions.

In various examples, the processor 202 may further train the predictive data model using additional (e.g., prior) event log data from a plurality of other IT devices and repair event data associated with the additional event log data, as previously described by FIG. 1.

FIG. 3 illustrates an example system that uses a predictive data model for predicting IT device failure, in accordance with examples of the present disclosure.

The system 325 includes a memory 336 and a processor 338, such as those described by FIG. 1 and/or FIG. 2. In some examples, the memory 336 and processor 338 may form part of a computing device 334. The computing device 334 may be local to an IT device 328 or may include the IT device 328 itself. In some examples, the computing device 334 is remote from the IT device 328. The computing device 334 and the IT device 328 may communicate between one another and with other devices using data communications over the network 330. In other examples, the memory 336 and processor 338 may form part of different computing devices.

The memory 336 may store a predictive data model and/or a trained predictive data model. The trained predictive data model may include the different patterns of event log data that result in failure of the IT device 328, such as repair events associated with different device components, as previously described. In examples, the processor 338 may train the predictive data model, as described by FIG. 1.

The processor 338 may track event log data for the IT device 328 and generate images of event codes within the event log data. An example image 332 is illustrated by FIG. 3. The processor 338 may classify a sliding window 346 associated with the image 332 as belonging to a failure window 344 or an operational window 342. The classification may be used to define a status of the IT device 328 based on the sliding window 346 belonging to one of the failure window 344 or the operational window 342.

FIG. 3 provides an example illustration 340 of a plurality of event codes in different sliding windows and a repair event from repair event data. The plurality of event codes and repair event data may be used to train the predictive data model, as previously described. As illustrated, the sliding window 346 may have a size ΔS that is smaller than a size ΔF of the failure window 344. Both ΔS and ΔF may be set during training of the predictive data model. As shown by the illustration 340, the failure window 344 may be used to predict a failure prior to the failure occurring and/or prior to the failure being reported as repair event data. The processor 338 may revise the trained predictive data model overtime based on feedback data, as previously described.

In some examples, the processor 338 may initiate a repair service on and/or for the IT device 328. For example, the processor 338 may provide a message to a repair service provider indicative of a predicted failure and/or a predicted component associated with the predicted failure. The repair service provider may include a human (e.g., a technician) that services the IT device 328 by visiting the location of the IT device 328 and/or that provides delivery of the replacement for the component.

In some examples, the system 325 includes a plurality of distributed computing devices used to provide an IT service, such as a printing device management service. The plurality of distributed computing devices may include servers and/or databases that form part of a cloud computing system. The memory 336 and processor 338 may form part of the plurality of distributed computing devices to provide the service. In some examples, one of the plurality of distributed computing devices may include the memory 336 and the processor 338. In other examples, the memory 336 may form part of a first distributed computing device and the processor 338 may form part of a second distributed computing device of the plurality.

The example system 325 may communicatively connect the plurality of distributed computing devices to a plurality of external devices over the network 330. The plurality of external devices may include a plurality of IT devices including the IT device 328 and/or a plurality of end-user computing devices including the computing device 334. Example end-user computing devices include desktop computers, laptops, tablets, and smartphones. In some such examples, the processor 338 may train the predictive data model and implement the predictive data model on the IT device 328.

However, examples are not so limited. In some examples, the memory 336 and processor 338 form part of the IT device 328, and the processor 338 implements a trained predictive data model. In some examples, the memory 336 and processor 338 form part of the computing device 334 and the processor 338 is to implement the trained predictive data model. In some examples, the computing device 334 may be in communication with the distributed computing devices and the trained predictive data model may be obtained from the cloud computing system over the network 330.

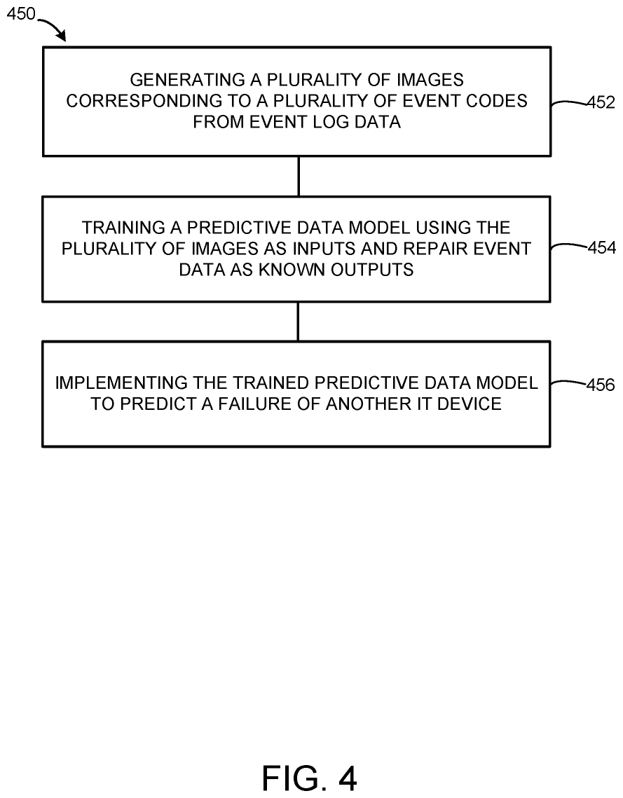

FIG. 4 illustrates an example method for training and implementing a predictive data model to predict a failure of an IT device, in accordance with examples of the present disclosure.

At 452, the method 450 includes generating a plurality of images corresponding to a plurality of event codes from event log data received from a plurality of IT devices. The event log data may be retrieved from the IT devices directly and stored on a memory, such as a distributed cloud resource.

At 454, the method 450 includes training a predictive data model using the plurality of images as inputs and repair event data associated with the plurality of IT devices as known outputs. For example, the predictive data model may be trained by: i) identifying a plurality of failure windows and operational windows associated with the plurality of IT devices, ii) classifying a plurality of sliding windows associated with the plurality of images as being one of a failure and operational based on the plurality of failure windows and the plurality of operational windows, and iii) identifying different patterns among the event log data that result in repair events based on the repair event data, the classified plurality of sliding windows, and the plurality of failure windows and operational windows, as previously described.

In various examples, the method 450 may include segregating the repair event data based on respective components associated with repair events and intersecting the segregated repair event data with the event log data associated with the respective components. For example, for each respective device component, the repair event data is segregated based on break-fix repair events associated with the respective component, such as repairs to the component and/or repairs caused by the component. The event log data is similarly segregated based on respective components and intersected with the segregated repair event data. In some examples, training the predictive data model may include identifying the plurality of failure windows and the plurality of sliding windows associated with failures of the respective components, classifying the plurality of sliding windows for each of the respective components, and identifying different patterns for each of the respective components.

At 456, the method 450 includes implementing the trained predictive data model on additional event log data to predict a failure of another IT device. Implementing the trained predictive data model may include testing the data model and/or implementing the model on subsequently received event log data. For example, implementing the trained predictive data model may include distributing the trained predictive data model to a plurality of distributed computing devices, each of the plurality of distributed computing devices to apply the trained predictive data to subsequently received event log data from subsets of IT devices and to predict failures among the subsets of IT devices. In some examples, implementing the trained predictive data model includes applying the trained predictive data to subsequently received event log data from a second plurality of IT devices and to predict failures among the second plurality of IT devices. In some examples, implementing the trained predictive data model includes testing the trained predictive data on test data.

As previously described, the method 450 may further include revising the trained predictive data model based on feedback data. The feedback data may include subsequently received event log data and/or repair data, such as data from implementing the predictive data model.

In various examples, the predictive data model is used to predict failure of the IT device and/or a specific device component. By predicting the failure, a service provider may initiate a replacement order of the component and/or service of the IT device in advance, thereby reducing costs caused by a rushed service, such as rushed labor costs (e.g., costs due to over time and/or holidays), and/or violating or triggering contractual agreed to terms that results in a penalty to the service provider, as described further below.

In some examples, users of IT devices may perform device operations within a contractual system involving IT services provided under a service agreement. In specific examples, the contractual system may include a print system that includes printing devices and/or print supplies which are provided to the customer by a service provider, and the service provider may maintain the printing devices, such as replacing components. The service provider may manage billing for providing the service, order replacement components and/or performing repairs on the printing device. In other examples, the service provider may provide a repair service.

The service agreement may have associated terms, such as print costs, guaranteed print qualities, time for repairs to occur, and penalties to the service provider for failure to meet a term. The service provider may be responsible for providing replacement components and repairs. As an example, a customer may contract with a service provider that is responsible for managing the health of the printing device, including repairing the printing device. The repair service provider may send an employee to the location of the printing device to repair the printing device, such as a local visit by an employee of the service provider to a location of the printing device to manage the health of the printing device (e.g., replacing components, replacing print supplies, and/or otherwise physically working on the printing device). In other examples and/or in addition, the service provider may order and/or deliver (e.g., initiate mailing) the replacement component to the location of the printing device or other location, such that the user or other personnel may replace the component. However, examples are not limited to print system and may include other types of contractual systems including IT devices and used to provide IT services.

In some examples, the contractual system may be cloud-based, which may be referred to as a “cloud-based print system”, and may provide a plurality of services, such a subscription service.

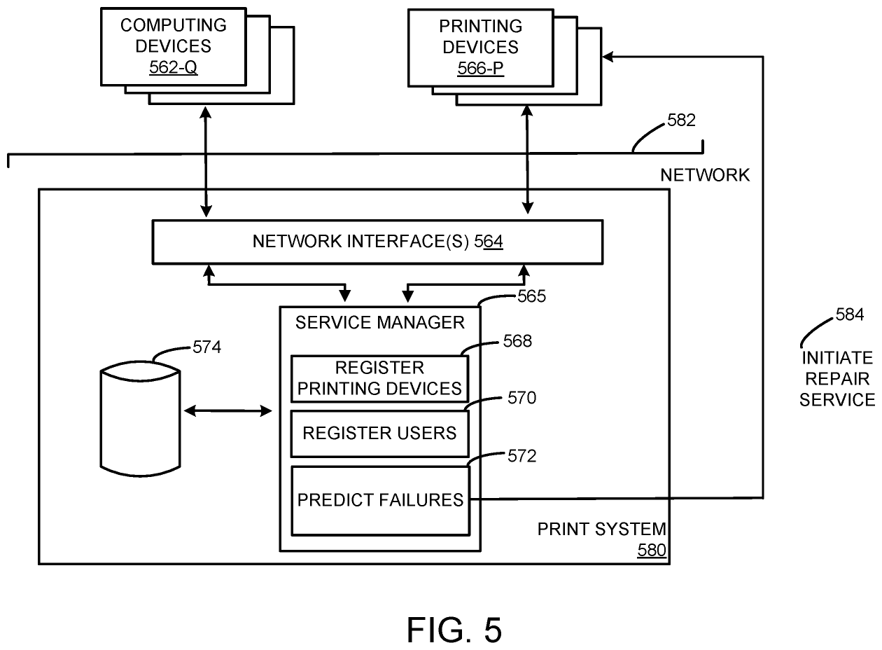

In various examples, the method 450 may be implemented by the IT device. In some examples, the method 450 may be implemented by a computing device local to the IT device, such as a local computer or a local server in communication with the IT device. In some examples, the method 450 may be implemented by a computing device remotely located from the IT device, such as a distributed processor that may be a part of a cloud computing system and used to implement an IT and/or print service. In further examples, the method 450 may be implemented using a combination of the IT device, the computing device local to the IT device and/or the remote computing device that form the system, as illustrated by FIG. 5.

FIG. 5 illustrates an example print system, in accordance with examples of the present disclosure. The print system 580 may provide a registration process for printing devices 566-P, and may manage repair services for the printing devices 566-P. The print system 580 may be implemented by a remote service provider. The print system 580 may be used to provide a portal to receive data as part of a registration process from printing devices 566-P and/or computing devices 562-Q and includes a service manager 565 to manage services for registered users. As described above, examples are not limited to print systems and may include other types of IT services.

The components of the print system 580 may be implemented using computer-readable instructions and/or on a computing device, such as a server, a laptop, a computing device, or on a plurality of distributed computing devices including distributed processor and memory resources that may communicate with one another and with other devices over the network 582. The computing device(s) may operate to execute computer-readable instructions, such as described above, to perform the processes described herein and related to the various components of the print system 580. The print system 580 may be cloud-based, for example, and/or may be implemented through other computer systems in alternative architectures, such as a peer-to-peer network.

The print system 580 may communicate with computing devices 562-Q and printing devices 566-P over the network 582 using a network interface 564. In various examples, the print system 580 includes a plurality of network interfaces for communicating over a plurality of networks, such as wireless and wired networks. In a specific example, the print system 580 communicates with the computing devices 562-Q and/or the printing devices 566-P via the network interface 564 and a portal or an application programming interface (API).

The print system 580 may include a service manager 565 that manages a plurality of services for users registered with the print system 580. The service manager 565 may provide a registration process in which a user registers the user or an associated organization with a print service, at 570, and may optionally register printing devices 566-P to be accessible, at 568. The service manager 565 stores the various data for registration in memory, such as in a database 574. Although one database 574 is illustrated, example print systems 580 include a plurality of databases stored on memory resources and which are accessible by a plurality of distributed processors which may implement the service manager 565.

In some examples, the registration process may include execution of a service agreement with the service provider. The service agreement may set out terms and parameters for providing the particular print service for the account. For example, the service agreement may specify a type of repair service and/or a threshold time for repairs to be completed.

The service manager 565 monitors use of the print services across the printing devices 566-P. For example, the service manager 565 may monitor the plurality of printing devices 566-P based on event log data and may predict failures 572 of the printing devices 566-P. In some examples, the service manager 565 may predict a failure 572 and initiate a repair service session 584 for the respective printing device. For example, the service manager 565 may order a replacement component, ship the replacement component to the customer, and/or schedule an employee of the service provider to visit the location of the printing device for the failure. The employee may travel to the location of the printing device and install the replacement component and/or otherwise initiate repairs.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A non-transitory computer-readable storage medium comprising instructions executable by a processor to cause the processor to:
receive data including:
event log data including a plurality of event codes from a plurality of information technology (IT) devices; and
repair event data indicative of failures of the plurality of IT devices;
generate a plurality of images corresponding to the plurality of event codes of the event log data;
train a predictive data model using the plurality of images as inputs to the predictive data model and the repair event data as known outputs to:
identify a plurality of failure windows and operational windows associated with the plurality of IT devices based on the repair event data and the event log data; and
classify a plurality of sliding windows associated with the plurality of images based on the plurality of failure windows and operational windows.

2. The non-transitory computer-readable storage medium of claim 1, wherein the instructions to cause the processor to train the predictive data model include instructions to identify different patterns among the event log data that result in repair events associated with different device components based on the classified plurality of sliding windows and the plurality of failure windows and operational windows.

3. The non-transitory computer-readable storage medium of claim 1, wherein:
the predictive data model includes a deep learning model;
the event log data includes the event codes and information indicative of dates associated with the plurality of event codes, and type and severity level of events associated with the plurality of event codes;
the event codes include information indicative of instructions received by the plurality of IT devices and indicative of respective components associated with the failures of the IT devices; and
the repair event data includes information indicative of an issue and identification of the respective component associated with the issue.

4. The non-transitory computer-readable storage medium of claim 1, wherein the event log data includes sequential information indicative of an order of respective event codes of the plurality, and the instructions to cause the processor to train the predictive data model include instructions to identify different patterns associated with the order of the respective event codes that result in repair events.

5. The non-transitory computer-readable storage medium of claim 1, wherein the instructions to cause the processor to train the predictive data model include instructions to select a size of the plurality of failure windows and a size of the plurality of sliding windows, wherein the sliding windows are a smaller size than the failure windows.

6. The non-transitory computer-readable storage medium of claim 1, further including instructions that when executed, cause the processor to test the trained predictive data model on test data, and based on performance of the test, adjust at least one of a size of the plurality of failure windows and a size of the plurality of sliding windows.

7. The non-transitory computer-readable storage medium of claim 1, further including instructions that when executed, cause the processor to:
implement the trained predictive data model to predict a failure of another IT device; and
revise the trained predictive data model based on feedback data, the feedback data being indicative of additional event log data and repair event data from the implementation.

8. A non-transitory computer-readable medium containing instructions executable by a processor to cause the processor to:
generate an image corresponding to an event code within a sliding window associated with an information technology (IT) device using received event log data from the IT device;
classify the sliding window associated with the image as belonging to a failure window or an operational window using a predictive data model applied to the image;
define a status of the IT device based on the classification of the sliding window as belonging to the failure window or the operational window; and
based on the defined status of the IT device, perform an action associated with the IT device.

9. The non-transitory computer-readable storage medium of claim 8, wherein the instructions to cause the processor to perform the action include instructions to predict a failure of the IT device and provide a message indicative of a recommendation to service the IT device based on the prediction.

10. The non-transitory computer-readable storage medium of claim 9, wherein the instructions to cause the processor to perform the action include instructions to determine a probability that the sliding window is within the failure window and the failure of the IT device.

11. The non-transitory computer-readable storage medium of claim 8, further including instructions that when executed, cause the processor to train the predictive data model using additional event log data from a plurality of other IT devices, and repair event data associated with the additional event log data, wherein the predictive data model includes a deep learning model.

12. A method comprising:
generating a plurality of images corresponding to a plurality of event codes from event log data received from a plurality of information technology (IT) devices;
training a predictive data model using the plurality of images as inputs and repair event data associated with the plurality of IT devices as known outputs by:
identifying a plurality of failure windows and operational windows associated with the plurality of IT devices based on the repair event data and the event log data;
classifying a plurality of sliding windows associated with the plurality of images as being one of a failure or an operational based on the plurality of failure windows and operational windows; and
identifying different patterns among the event log data that result in repair events based on the repair event data, the classified plurality of sliding windows, and the plurality of failure windows and operational windows; and
implementing the trained predictive data model on additional event log data to predict a failure of another IT device.

13. The method of claim 12, wherein implementing the trained predictive data model includes distributing the trained predictive data model to a plurality of distributed computing devices, each of the plurality of distributed computing devices to apply the trained predictive data to subsequently received event log data from subsets of IT devices and to predict failures among the subsets of IT devices.

14. The method of claim 12, wherein implementing the trained predictive data model includes applying the trained predictive data to subsequently received event log data from a second plurality of IT devices and to predict failures among the second plurality of IT devices.

15. The method of claim 12, wherein implementing the trained predictive data model includes testing the trained predictive data on test data.

16. The method of claim 12, further comprising revising the trained predictive data model based on feedback data, the feedback data including subsequently received event log data and repair event data.

17. The method of claim 12, further comprising:
segregating the repair event data based on respective components associated with repair events;
intersecting the segregated repair event data with the event log data associated with the respective components; and
wherein training the predictive data model includes:
identifying the plurality of failure windows and the plurality of sliding windows associated with failures of the respective components;
classifying the plurality of sliding windows for each of the respective components; and
identifying different patterns for each of the respective components.
